(19) United States
(12) Patent Application Publication
(10) Pub. No.: US 2006/0190704 A1
(43) Pub. Date: Aug. 24, 2006

(54) Apparatus for increasing addressability of registers within a processor

(75) Inventors: Peter G. Capek, Ossining, NY (US); Robert K. Montoye, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/065,602

(22) Filed: Feb. 24, 2005

(51) Int. Cl. G06F 9/30

(52) U.S. Cl. 712/217

(57) ABSTRACT

An apparatus for increasing addressability of registers within a processor is disclosed. The apparatus includes a set of apparent registers and a set of real registers. The total number of real registers is substantially higher than the total number of apparent registers such that only a subset of the real registers is referenced by all of the apparent registers at any given time. Any one of the real registers can be designated by an instruction via one of the apparent registers. Any one of the actual registers can also be directly designated by an instruction.

### BACKGROUND OF THE INVENTION

1. Technical Field

The present invention relates to processors in general, and, in particular, to registers within a processor. Still more particularly, the present invention relates to an apparatus for increasing the ability of a processor to address registers.

2. Description of Related Art

Within a processor, registers can be used to store various data intended for manipulations. When it comes to data manipulations, registers are preferred over a system memory in many aspects. For example, registers can typically be designated by fewer bits in instructions than locations in system memory require to be addressed. In addition, registers have higher bandwidth and shorter access time than most system memories. Furthermore, registers are relatively straight-forward to design and test. Thus, modern processor architectures tend to have a relatively large number of registers.

Although the performance of a processor can generally be improved by increasing the number of registers within the processor, a large number of registers can also present its own problems. One of the problems is register addressability. If a processor includes a large number of addressable registers, each instruction having one or more register designations would require many bits to be allocated solely for the purpose of addressing registers. For example, if a processor has thirty-two registers, a total of twenty bits will be required to designate four registers within an instruction because five bits are needed to address all thirty-two registers. Thus, the maximum number of registers that can be provided within a processor architecture is effectively constrained.

Indirection is a technique that has been used to access large register files. An indirection mechanism useful for extending an architecture such as the PowerPC™ architecture to accommodate potentially very large register files should satisfy the following objectives:
1. compatibility with the standard PowerPC instruction format;
2. ability to execute previously existing code without recompilation;
3. sufficient flexibility to support loop unrolling, software pipelining, and related software techniques used to mitigate the effects of long pipeline latencies; and
4. sufficient flexibility to support software techniques for maintaining appropriately large subsets of the working data set in the register file within inner loops.

Prior art indirection mechanisms for accessing large register files fail to meet one or more of the above-mentioned objectives. Such prior art indirection mechanisms include:
Itanium (see, for example, “Intel Itanium Architecture Software Developer's Manual”, October 2002) employs a technique referred to as “rotating registers” to provide indirect access to contiguous sets of registers from the upper 96 registers in register files with 128 registers. Itanium is useful for loop unrolling but not for taking advantage of the large register files in more general ways (e.g., to satisfy objective 4).
“Register queues” (Tyson et al., IEEE Trans. Computers, August 2001) are similar in some respects to rotating registers, with apparently increased flexibility in defining establishing access to the contiguous register sets. Because the indirect access is still constrained to be to sets of contiguous registers, there is insufficient flexibility to satisfy objective 4.
“Register connection” (Kiyohara et al., in Proc. 1993, ISCA) appears to be a more general and thus more flexible mechanism for indirect access to large register files than rotating registers and register queues. However, it is limited in that, if used with the PowerPC™ architecture, only 32 registers would be accessible by the instructions issued in any particular cycle, due to the mechanism used to map registers names coded in an instruction to actual physical registers in the register file.
eLite (see, for example, Moreno et al., U.S. patent application, US20040015677A1, Ser. No. ______) employed an extremely flexible indirection mechanism for access to a register file with 512 registers. However, the mechanism is specific to a SIMD architecture and cannot be morphed to a backward-compatible extension to the PowerPC architecture.

Consequently, it would be desirable to provide an improved apparatus for increasing the ability of a processor to address registers.

### SUMMARY OF THE INVENTION

In accordance with a preferred embodiment of the present invention, an apparatus for increasing addressability of registers within a processor includes a set of apparent registers and a set of actual registers. The total number of actual registers is substantially higher than the total number of apparent registers such that only a subset of the actual registers is referenced by all of the apparent registers at any given time. Any one of the actual registers can be designated by an instruction via one of the apparent registers. Any one of the actual registers can also be directly designated by an instruction.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a processor in which a preferred embodiment of the present invention is incorporated; and

FIG. 2 graphically depicts an apparatus for increasing addressability of registers within the processor from FIG. 1, in accordance with a preferred embodiment of the present invention.

### DETAILED DESCRIPTION OF A PREFERRED EMBODIMENT

The present invention may be implemented in reduced instruction set computing (RISC) processors or complex instruction set computing (CISC) processors. For the purpose of illustration, a preferred embodiment of the present invention, as described below, is implemented on a RISC processor, such as the PowerPC™ family processor manufactured by the International Business Machines Corporation of Armonk, N.Y.

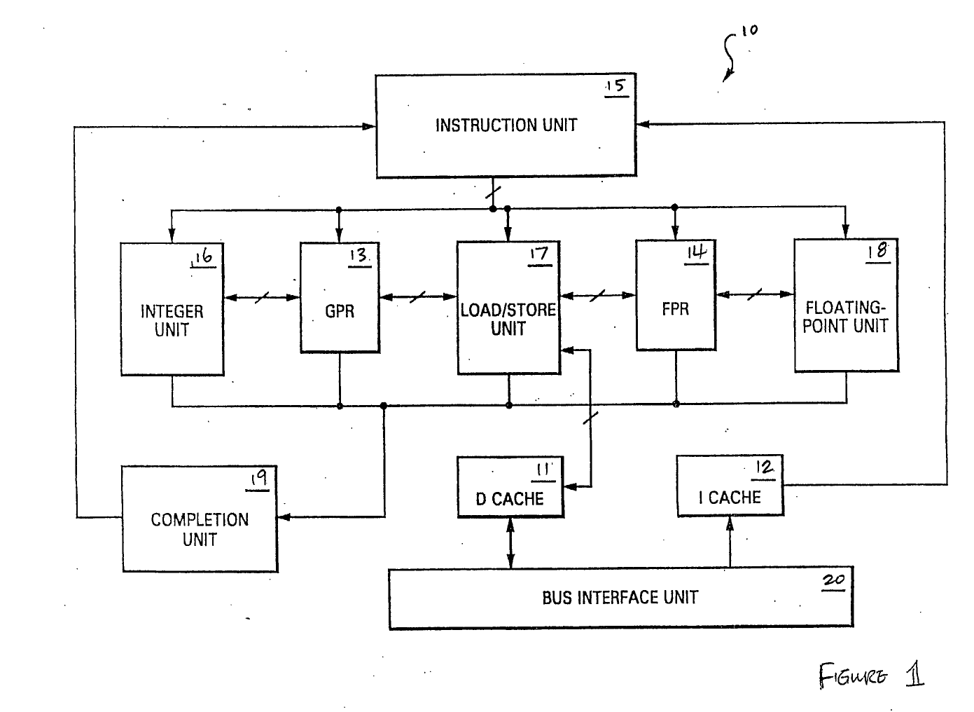

Referring now to the drawings and in particular to FIG. 1, there is depicted a block diagram of a processor in which a preferred embodiment of the present invention is incorporated. As shown, a processor 10 includes a data cache 11 and an instruction cache 12. Data cache 11 and instruction cache 12 are both connected to a bus interface unit 20. Instructions are retrieved from a system memory (not shown) to processor 10 through bus interface unit 20 and are stored in instruction cache 12. Data retrieved through bus interface unit 20 are stored in data cache 11. Instructions are fetched as needed from instruction cache 12 by an instruction unit 15 that includes an instruction fetcher, a branch prediction module, an instruction queue and a dispatch unit.

Instruction unit 15 dispatches instructions as appropriate to execution units such as an integer unit 16, a load/store unit 17 and/or a floating-point unit 18. Integer unit 16 performs add, subtract, multiply, divide, shift or rotate operations on integers, retrieving operands from and storing results to general-purpose registers 13. Floating-point unit 18 performs single-precision and/or double-precision multiply/add operations, retrieving operands from and storing results to floating-point registers 14. Load/store unit 17 loads instruction operands from data cache 11 into general-purpose registers 13 or floating-point registers 14, as needed, and stores instructions results when available from general-purpose registers 13 or floating-point registers 14 into data cache 11.

A completion unit 19, which includes multiple reorder buffers, operates in conjunction with instruction unit 15 to support out-of-order instruction processing. Completion unit 19 also operates in connection with rename buffers within general-purpose registers 13 and floating-point registers 14 to avoid any conflict in a specific register for instruction results.

In accordance with a preferred embodiment of the present invention, a set of apparent registers is used to increase the addressability of a set of actual registers within a processor. The apparent registers are addressed in a space called the apparent register name space, and the actual registers are addressed in a larger space called the actual register name space. Entries in the apparent registers refer to names of registers in the actual register name space. The apparent register name space is directly addressable by a register number used in an instruction. On the other hand, the actual register name space can be addressed either directly (from some instructions) or indirectly through values stored in the apparent registers.

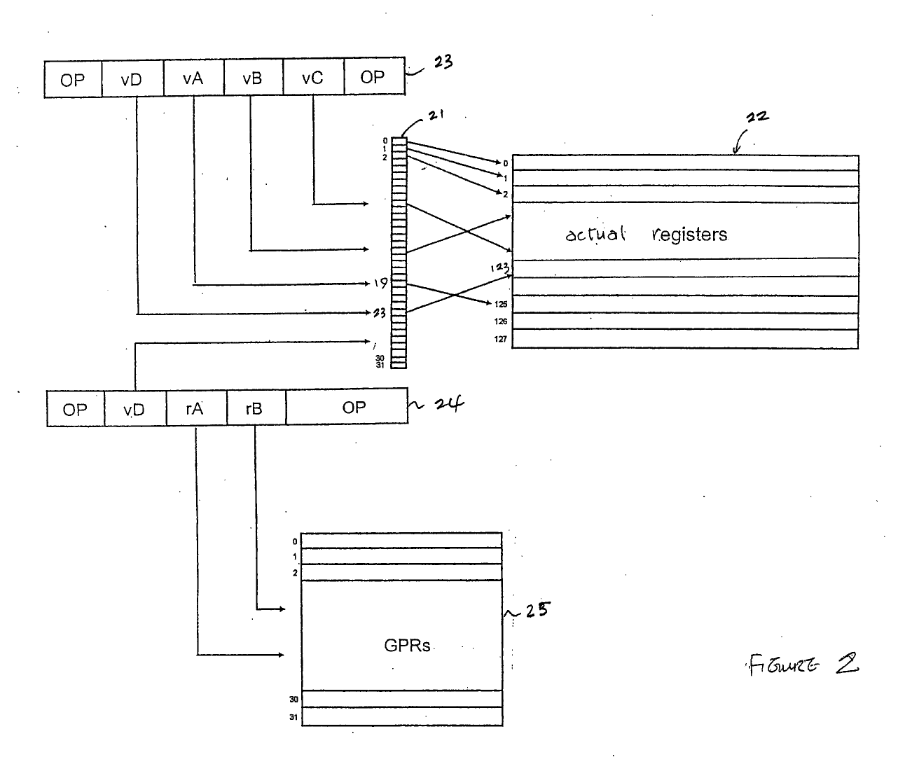

With reference now to FIG. 2, there is depicted a set of apparent registers and a set of actual registers, in accordance with a preferred embodiment of the present invention. As shown, apparent registers 21 include multiple register entries. The total number of register entries within apparent registers 21 preferably equals to two to the power of the number of bits in an apparent register field within an instruction 23 reserved for addressing registers. For example, if the number of bits in a register field within instruction 23 is three, then the number of register entries within apparent registers 21 is eight; if the number of bits in an apparent register field within instruction 23 is four, then the number of register entries within apparent registers 21 is sixteen. In the embodiment shown in FIG. 2, the number of bits in apparent register fields, such as vA field, vB field, vC field and vD field, within instruction 23 is five, and the number of register entries within apparent registers 21 is thirty-two. In the context of PowerPC™, vA, vB, vC and vD fields are the names of vector (or VMX or Altivec) registers, and a preferred embodiment of the present invention refers to the PowerPC™ vector registers.

Actual registers 22 also include multiple register entries. The number of bits in each apparent register entry is large enough to address the number of provided actual registers, possibly allowing space for future growth in that number. The total number of registers within actual registers 22 preferably equals to at least two to the power of the number of bits within a register entry of apparent registers 21. For example, if the number of bits within each register entry of apparent register 21 is five, then the total number of registers within actual registers 22 is thirty-two; if the number of bits within each register entry of apparent registers 21 is six, then the total number of registers within actual registers 22 is sixty-four. In the embodiment shown in FIG. 2, the number of bits within each register entry of apparent registers 21 is seven, and the total number of registers within actual registers 22 is 128.

During operation, a register within actual registers 22 is selected by the bits within a register entry of apparent registers 21, which is selected by the bits within an apparent register field of an instruction, such as instruction 23. For example, as shown in FIG. 2, register 123 within actual registers 22 is selected by the bits within register entry 23 of apparent registers 21, which is selected by the bits within apparent register field vD of instruction 23. Similarly, register 125 within actual registers 22 is selected by the bits within register entry 19 of apparent registers 21, which is selected by the bits within apparent register field vA of instruction 23.

An instruction may include two different types of register fields. As shown in FIG. 2, an instruction 24 includes an apparent register vD field for indexing into apparent registers 21, as mentioned above. Instruction 24 also include standard register fields, such as an rA field and an rB field, for directly indexing into a set of general-purpose registers 25. The total number of registers in general-purpose registers 25 are much less than the total number of registers in actual registers 22. Since the number of bits in each of rA field and rB field is five, the maximum number of registers in general-purpose registers is limited to thirty-two.

The control of apparent registers 21 can be designed in a way that is appropriate for the processor architecture in which the present invention is incorporated. In the PowerPC™ architecture, for example, it may be appropriate to control the mapping through two or more special purpose registers.

The register re-mapping of the present invention can be applied to different sets of registers independently. For example, in the context of the PowerPC™ architecture, the register re-mapping may be applied to vector registers and to floating-point registers but not to general-purpose registers.

A special instruction can be used to change the mapping of some or all of the register entries within apparent registers 21 at once. Certain instructions, such as Load and Store instructions, which can directly address the entire set of actual registers 22, at the cost of providing, in the instruction, sufficient bits to address the fill complement of the actual registers.

The result of a standard arithmetic instruction can be moved into one of apparent registers 21 and that value is then used to address one of actual registers 22. Doing so would make it easy to perform arithmetic on the register mapping, such as incrementing a register entry number within apparent registers 21. Such mapping is similar to incrementing an address register used to address a conventional system memory.

Additionally, instructions may be provided which increment and/or decrement, by one or by an integer specified in the instruction, the value in a specific apparent register.

It is also valuable to allow different mappings for each of the register designations commonly used in an instruction set, and to allow different mappings for each of the source operands. Thus, one mapping could be used for target operands, and another used for source operands. For example, in the PowerPC™ architecture, one mapping is for vD, and a separate one for vA and vB. The usage of independent mappings for vA and vB could be valuable and would serve to increase the number of addressable registers in the working set.

As has been described, the present invention provides an apparatus for increasing addressability of registers within a processor. The present invention can be implemented in a compatible way into an existing processor architecture.

While the invention has been particularly shown and described with reference to a preferred embodiment, it will be understood by those skilled in the art that various changes in form and detail may be made therein without departing from the spirit and scope of the invention.

What is claimed is:

1. An apparatus for increasing addressability of registers within a processor, said apparatus comprising:
a set of apparent registers; and
a set of actual registers, wherein the number of said actual registers is greater than the number of said apparent registers such that only a subset of said actual registers is referenced by all of said apparent registers at any given time, wherein any one of said actual registers is capable of being designated by an instruction via at least one of said apparent registers, wherein any one of said actual registers is also capable of being directly designated by an instruction.

2. The apparatus of claim 1, wherein a total number of register entries within said apparent registers is equal to two to the power of the number of bits in an apparent register field within an instruction reserved for addressing registers.

3. The apparatus of claim 1, wherein a total number of registers within said actual registers is equal to at least two to the power of the number of bits within a register entry of said apparent registers.

4. The apparatus of claim 1, wherein a mapping of all of said register entries within said apparent registers is changed at once by a special instruction.

5. The apparatus of claim 1, wherein a first mapping of some of said register entries within said apparent registers is used for target operands, and a second mapping of some of said register entries within said apparent registers is used for source operands.

6. The apparatus of claim 1, wherein each of said source and destination register designations is mapped by an independent set of mapping registers.

7. A method for increasing addressability of registers within a processor, said method comprising:
providing a set of apparent registers; and
providing a set of actual registers, wherein the number of said actual registers is greater than the number of said apparent registers such that only a subset of said actual registers is referenced by all of said apparent registers at any given time, wherein any one of said actual registers is capable of being designated by an instruction via at least one of said apparent registers, wherein any one of said actual registers is also capable of being directly designated by an instruction.

8. The method of claim 7, wherein a total number of register entries within said apparent registers is equal to two to the power of the number of bits in an apparent register field within an instruction reserved for addressing registers.

9. The method of claim 7, wherein a total number of registers within said actual registers is equal to at least two to the power of the number of bits within a register entry of said apparent registers.

10. The method of claim 7, wherein a mapping of all of said register entries within said apparent registers is changed at once by a special instruction.

11. The method of claim 7, wherein a mapping of a subset of said register entries within said apparent registers is changed at once by a special instruction, wherein said special instruction copies the values of several apparent registers to an unrelated register, or from an unrelated register to said several apparent registers.

12. The method of claim 7, wherein a first mapping of some of said register entries within said apparent registers is used for target operands, and a second mapping of some of said register entries within said apparent registers is used for source operands.

13. The method of claim 7, wherein each of said target registers and each of said source registers is mapped by an independent set of mapping registers.
